(19) United States
(12) Patent Application Publication
(10) Pub. No.: US 2025/0217912 A1
(43) Pub. Date: Jul. 3, 2025

(54) METHOD FOR PROVIDING WEBCAM STUDY MANAGEMENT SERVICE FOR PRIVATE EDUCATIONAL INSTITUTE

(71) Applicant: GOOROOMEE CO., LTD., Seoul (KR)

(72) Inventor: Rang Hyuck LEE, Seoul (KR)

(21) Appl. No.: 19/024,720

(22) Filed: Jan. 16, 2025

Related U.S. Application Data
(63) Continuation of application No. PCT/KR2023/010292, filed on Jul. 18, 2023.

(30) Foreign Application Priority Data
Jul. 18, 2022 (KR) 10-2022-0087918

(51) Int. Cl. G06Q 50/20; G06Q 10/1091; G06V 10/82; G06V 20/52; G08B 21/18

(52) U.S. Cl. CPC G06Q 50/205; G06Q 10/1091; G06V 10/82; G06V 20/52; G08B 21/18

(57) ABSTRACT

A method for providing a webcam study management service for private educational institute by a server includes providing a administer page to an academy terminal, receiving a request for opening an open webcam study room from the academy terminal and generating the open webcam study room by being matched to identification information of the academy terminal, exposing the open webcam study room generated by the server when a student terminal accesses the academy terminal, accepting an entry request when the student terminal requests to enter to the open webcam study room, providing videos of other students who have already entered in the open webcam study room, shooting a video of the student using the accessed student terminal, and transmitting the shooted video to terminals of the other students.

### TECHNICAL FIELD

The present disclosure relates to a method for providing webcam study management service for private educational institute, and more specifically, to an academy that establishes a learning guidance plan through the study records of students using an academy terminal, and students that access an open webcam study room provided by the academy terminal through the student terminal, transmit a learning scene through a cam of the student terminal, and store the study records.

### BACKGROUND

The size of the domestic private education market in 2021 was approximately 23.4 trillion won, which indicates an increase of approximately 21% compared to 19.4 trillion won in 2020. In addition, an average monthly private education expense per person is also 367,000 won, which indicates an increase by approximately 21.5% compared to 2021. Accordingly, as the private education market grows, it is important for academies to increase students' grades and provide motivation such that the students may focus on their studies.

Previously, students were allowed to study in a reading room or library operated by the academy even outside of academy classes. However, it is not easy for academies that do not have enough classrooms or are not large in size to operate a reading room or library. In addition, recently, the number of students who want to study remotely has been increased. Also, the proportion of academies using spaces used as reading rooms or libraries as classrooms for students' classes has increased. Accordingly, there is a need for a method for providing a webcam study management service that may satisfy the conditions described above and provide a learning environment without device restrictions and location restrictions.

### DETAILED DESCRIPTION

### Problems to be Solved by the Invention

The present disclosure is to provide a webcam study management service for private educational institute such that a student terminal may access a server and access an open webcam study room generated by an academy terminal or another student terminal to perform learning and store a record thereof in the server such that the academy terminal may organically manage the learning situation of the student terminals.

However, technical issues to be solved by the present embodiment are not limited to the technical issue described above, and other technical issues may exist.

### Means for Solving the Problems

According to an aspect of the present disclosure, a method for providing a webcam study management service for private educational institute by a server includes providing a administer page to an academy terminal, receiving a request for opening an open webcam study room from the academy terminal and generating the open webcam study room by being matched to identification information of the academy terminal, exposing the open webcam study room generated by the academy terminal when a student terminal accesses the server, accepting an entry request when the student terminal requests to enter to the open webcam study room, providing videos of other students who have already entered in the open webcam study room, shooting a video of the student using the accessed student terminal, and transmitting the video to terminals of the other students; and recording study time of the student based on a time period when the student terminal accesses the open webcam study room and engages in study activities, and transmitting a recording result to the academy terminal.

Also, in the providing of the administer page, an account that is accessible to the administer page may be issued, the account may include a administer account and an observer account, the administer account may have an authority to search for a study record related to study hours of students registered in the academy, the observer account may be accessible to the open webcam study room generated by the academy terminal and enable videos of all student terminals accessing the open webcam study room, and existence of the academy terminal may not be exposed to the all student terminals, and the administer account and the observer account may be integrated to be issued as a single account.

Also, in the recording of the study time, by accessing with the administer account, cumulative study times of the student terminal, the open webcam study room of the academy, and study record information for each student terminal may be checked on the administer page, the server may store a time when the student terminal accesses the open webcam study room and data of a study time and a break time measured by a study record timer, the data may be provided to the academy terminal to be checked with the administer account when there is a request from the academy terminal, and a study record for each period of the student terminal and an opening history of the open webcam study room may be provided to the academy terminal.

Also, in the exposing of the open webcam study room, the accepting of the entry request, the providing of the videos, the shooting of the video, and the transmitting of the video, when the student terminal accesses the server, the identification information of the academy terminal that is previously stored may be recognized by being matched to the student terminal, identification information of the open webcam study room generated by the academy terminal may be transmitted to the student terminal such that the open webcam study room is exposed to the student terminal, the student terminal may access the open webcam study room generated by an academy to which the student is registered or accesses any open webcam study room, and performs study by using the study record timer, the study record timer may measure a study start time and a study end time of the student and sets break time alarm, and change values of image pixels received from the student terminal may be checked in real time, and when the change values of the image pixels are zero for a preset time or longer, the student may be determined to leave a seat without studying, and an alarm message is provided to the student terminal.

Also, in the exposing of the open webcam study room, the accepting of the entry request, the providing of the videos, the shooting of the video, and the transmitting of the video, when the student terminal enters the open webcam study room, the change values of the video pixels may be monitored in real time, when the change values of the video pixels are zero for a preset time or longer, the student may not sit in a seat without studying, when the student is determined to be not in the seat for the preset time or longer, a current time and a previously stored class timetable of the student terminal may be compared to each other, and whether the current time is included in any class time range of the class timetable of the student terminal may be checked, and when the current time is included in the class time range, the student terminal may be recognized to participate in a class.

Also, the exposing of the open webcam study room, the accepting of the entry request, the providing of the videos, the shooting of the video, and the transmitting of the video may include opening a chatting window set in one region of a screen of the open webcam study room and inputting a question when the student terminal enters the open webcam study room and has a question about study while performing the study; classifying, by the server, items of the question through a pre-learned question classification model; determining to which model among multiple artificial intelligence learning models the question is input by referring to a classification value and inputting the question to a determined model and outputting an answer; and transmitting an output answer to the student terminal, the items may be included in one subject studied by the student terminal, and the multiple artificial intelligence learning models may be trained with learning data consisting of different question data and answer data in pairs according to the items.

Also, a pre-set artificial intelligence model may analyze the study record, and the student terminal may show rankings of preset items.

Also, the preset artificial intelligence model may collect study data including a study record, a study time zone, a study time for each subject, an average score of subjects solved during self-study time, and study concentration for each student terminal, and derives self-study efficiency of the student terminal by referring to subject scores of test results executed at each preset period, the study record may include a time when the open webcam study room is generated by accessing the server and a time when the open webcam study room is closed, the study time for each subject may be estimated by directly inputting subject information by the student terminal or by extracting a text in a test paper image received through a camera of the student terminal, the average score of the subjects solved during the self-study time may be identified from scores when the student terminal accesses the open webcam study room and solves a problem for each subject provided through the server, the study concentration may be identified by detecting a case where the student dozes off or sleeps face down through the camera, and study may be performed by using a model based on at least one of RNN, LSTM, and CNN by setting the study data and monthly mock test scores for each subject of a related student terminal as input values and by setting the self-study efficiency of the student terminal as an output value.

Also, when the student terminal is matched to multiple academy terminals and each of the multiple academy terminals has the administer account, even when the student terminal accesses the open webcam study room generated by one of the multiple academy terminals and performs study, a record of the study time performed by the student terminal may also be provided to accounts of other academy terminals.

### EFFECTS OF THE INVENTION

According to another aspect of the present disclosure, a device for providing a webcam study management service for private educational institute includes a memory storing a program for the webcam study management service for the academy; and a processor configured to execute the program, wherein the processor performs an operation of providing a administer page to an academy terminal; an operation of receiving a request for opening an open webcam study room from the academy terminal and generating the open webcam study room by being matched to identification information of the academy terminal; an operation of exposing the open webcam study room generated by the academy terminal when a student terminal accesses the server, accepting an entry request when the student terminal requests to enter to the open webcam study room, providing videos of other students who have already entered in the open webcam study room, shooting a video of the student using the accessed student terminal, and transmitting the video to terminals of the other students; and an operation of recording study time of the student based on a time period when the student terminal accesses the open webcam study room and engages in study activities, and transmitting a recording result to the academy terminal.

### BRIEF DESCRIPTION OF THE DRAWINGS

Embodiments of the inventive concept will be more clearly understood from the following detailed description taken in conjunction with the accompanying drawings in which:

FIG. 1 is a structural diagram of a method for providing a webcam study management service for private educational institute, according to an embodiment of the present disclosure;

FIG. 2 is a structural diagram of a server for a method for providing a webcam study management service for private educational institute, according to an embodiment of the present disclosure;

FIG. 3 is a flowchart illustrating a process of a method for providing a webcam study management service for private educational institute, according to an embodiment of the present disclosure;

FIG. 4 is an example diagram illustrating a screen for accessing a manager system of a method for providing a webcam study management service for private educational institute, according to an embodiment of the present disclosure;

FIGS. 5 to 11 are example diagrams illustrating pages that may be checked and searched with a administer account through an academy terminal for a method for providing a webcam study management service for private educational institute, according to an embodiment of the present disclosure;

FIG. 12 is an example diagram illustrating a login screen for accessing a server by a student terminal for a method for providing a webcam study management service for private educational institute, according to an embodiment of the present disclosure;

FIG. 13 and FIG. 14 illustrate examples of pages for information that may be searched by accessing a student terminal for a method for providing a webcam study management service for private educational institute, according to one embodiment of the present disclosure; and

FIG. 15A to FIG. 15D are example views illustrating a monitoring screen of a student terminal according to an embodiment of the present disclosure.

### DETAILED DESCRIPTION OF THE EMBODIMENTS

Hereinafter, embodiments of the present disclosure will be described in detail with reference to the attached drawings such that those skilled in the art to which the present disclosure belongs may easily practice the present disclosure. However, the present disclosure may be implemented in various different forms and is not limited to the embodiments described herein. In addition, in order to clearly describe the present disclosure in the drawings, parts that are not related to the description are omitted, and similar components are given similar reference numerals throughout the specification.

In the entire specification of the present disclosure, when a component is described to be “connected” to another component, this includes not only a case where the component is “directly connected” to another component but also a case where the component is “electrically connected” to another component with another element therebetween. Also, when it is described that a portion “includes” a certain component, this means that the portion may further include another component without excluding another component unless otherwise stated.

In the present disclosure, a “portion” includes a unit realized by hardware, a unit realized by software, and a unit realized by using both. In addition, one unit may be realized by using two or more pieces of hardware, and two or more units may be realized by using one piece of hardware. Meanwhile, a “˜portion” is not limited to software or hardware, and a “˜portion” may be configured to be included in an addressable storage medium or may be configured to reproduce one or more processors. Therefore, in one example, “˜portion” refers to components, such as software components, object-oriented software components, class components, and task components, and includes processes, functions, properties, and procedures, subroutines, segments of program code, drivers, firmware, microcode, circuits, data, databases, data structures, tables, arrays, and variables. The functions provided within the components and “portions” may be combined into a smaller number of components and “portions” or may be further separated into additional components and “portions”. Additionally, components and “portions” may be implemented to regenerate one or more central processing units (CPUs) included in a device or security multimedia card.

The “user terminal” described below may be implemented by a computer or portable terminal that may access a server or other terminals through a network. Here, a computer may include, for example, a laptop computer, a desktop computer, virtual reality (VR) head mounted display (HMD) (for example, HTC VIVE, Oculus Rift, GearVR, DayDream, PSVR, or so on), or so on in which a web browser is installed. Here, the VR HMD include an HMD for a personal computer (PC) (for example, HTC VIVE, Oculus Rift, FOVE, Deepon, or so on), a mobile HMD (for example, GearVR, DayDream, Storm Magic, Google Cardboard, or so on), a console HMD (PSVR), an independently implemented Stand Alone model (for example, Deepon, PICO, or so on), and so on. A mobile terminal is, for example, a wireless communication device that guarantees portability and mobility and may include not only a smartphone, a tablet personal computers (PC), or a wearable device, but also various devices equipped with communication modules of Bluetooth (Bluetooth low energy (BLE)), near field communication (NFC), radio frequency identification (RFID), ultrasonic, infrared, WiFi, LiFi, or so on. In addition, a “network” refers to a connection structure capable of exchanging information between nodes, such as a terminal and a server and includes a local area network (LAN), a wide area network (WAN), the Internet (WWW: World Wide Web), a wired and wireless data communications network, a telephone network, a wired and wireless television communication network, and so on. For example, the wireless data communication network includes third generation (3G), fourth generation (4G), fifth generation (5G), third generation partnership project (3GPP), long term evolution (LTE), world interoperability for microwave access (WIMAX), Wi-Fi, Bluetooth communication, infrared communication, ultrasonic communication, visible light communication (VLC), LiFi, and so on but are not limited thereto.

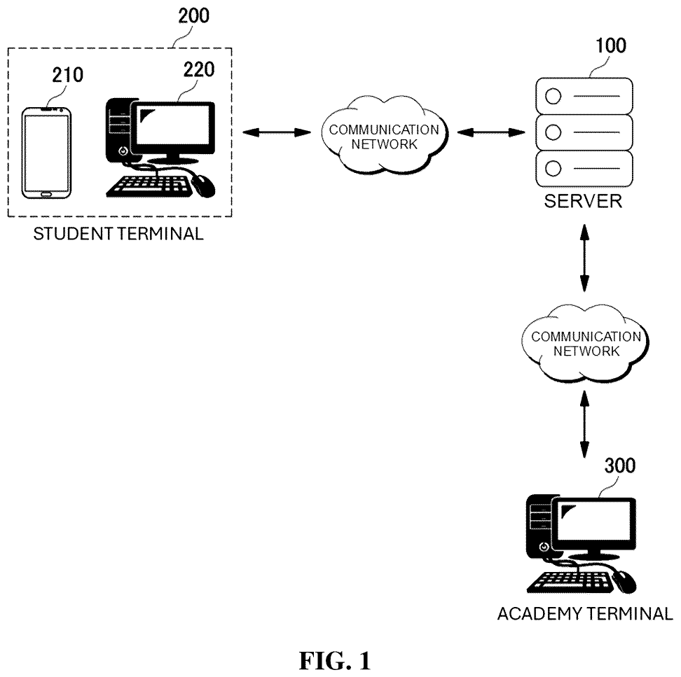

First, a structure for a method for providing a webcam study management service for private educational institute, according to an embodiment of the present disclosure, will be described with reference to FIG. 1.

Referring to FIG. 1, a system for a method for providing a webcam study management service for private educational institute, according to an embodiment of the present disclosure, includes a server 100, a student terminal 200, and an academy terminal 300.

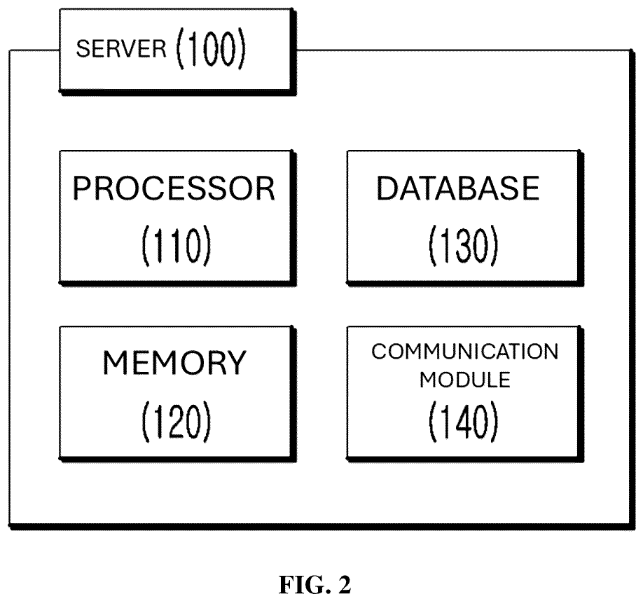

Hereinafter, a structure of the server 100 for a method for providing a webcam study management service for private educational institute, according to an embodiment of the present disclosure, will be described with reference to FIG. 2.

Referring to FIG. 2, the server 100 includes a processor 110, a memory 120, a database 130, and a communication module 140.

The processor 110 executes a webcam study management service program stored in the memory 120 to provide a user interface to the academy terminal 300 and the student terminal 200, and processes operations corresponding to inputs of the academy terminal 300 and the student terminal 200.

The memory 120 stores the webcam study management service program, and provides the webcam study management service program to the academy terminal 300 and the student terminal 200 through the processor 110.

The database 130 records and stores results of the operations performed by the academy terminal 300 and the student terminal 200 through the processor 110, and provides the previously stored records requested by the academy terminal 300 and the student terminal 200 connected to the webcam study management service program executed through the memory 120.

The communication module 140 transmits the webcam study management service program stored in the memory 120 provided by the processor 110 to user interfaces of the academy terminal 300 and the student terminal 200 through a communication network.

The student terminal 200 includes a mobile student terminal 210 and a fixed student terminal 220. The mobile student terminal 210 includes a smartphone and a tablet personal computer (PC), and the mobile student terminal 210 is not limited thereto. The fixed student terminal 220 includes a desktop computer, a laptop computer, and a kiosk, and the fixed student terminal 220 is not limited thereto. The student terminal 200 may access the server 100 through a communication network to receive a user interface of the webcam study management service program, access an open webcam study room that is opened, perform study, or open an open webcam study room directly to perform study, and record results of the study in the server 100.

The academy terminal 300 may access the server 100 through a communication network, receive the user interface of the webcam study management service program, open an open webcam study room, or check the results of the study that the student terminal 200 records in the server 100.

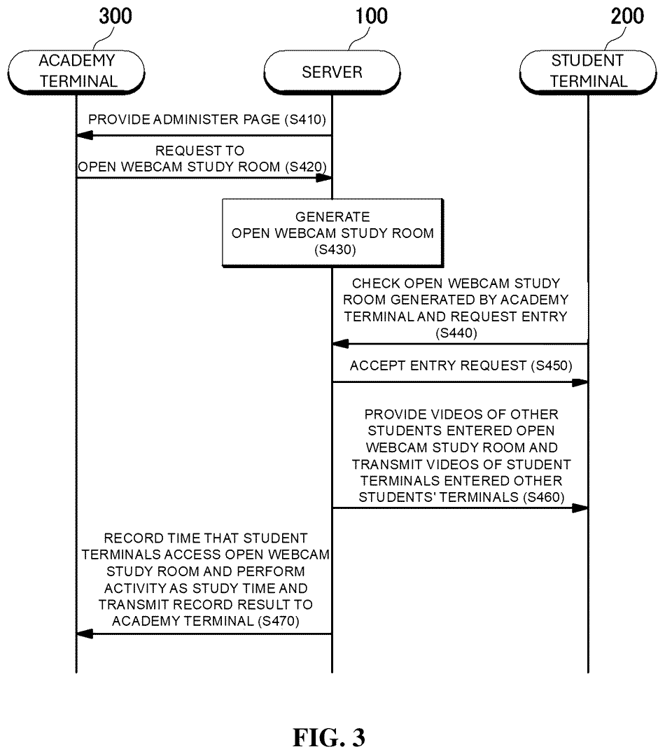

Hereinafter, a process of a method for providing a webcam study management service for private educational institute, according to an embodiment of the present disclosure, will be described in detail with reference to FIG. 3.

First, the server 100 provides a administer page to the academy terminal 300 (S410). As the server 100 provides the administer page to the academy terminal 300, the academy terminal 300 may access the administer account. The academy terminal 300 performs access by inputting an identification (ID) and password of the previously provided administer account. The academy terminal 300 may access the server 100 with the administer account and search study record related to the study time of the registered student terminal 200.

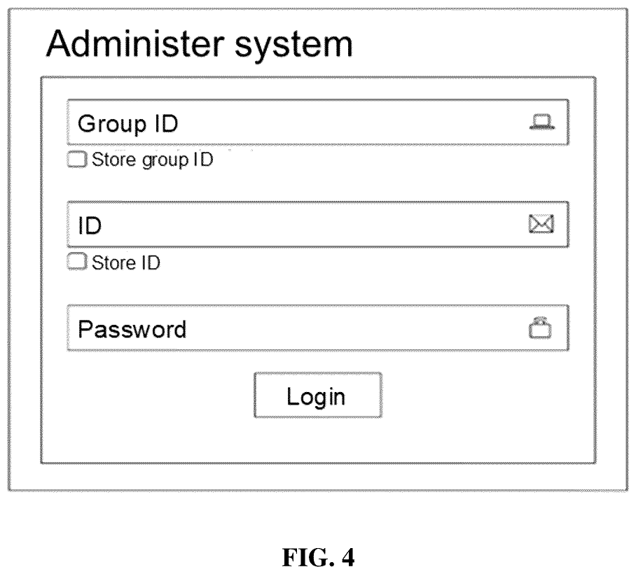

Items that may be checked with the administer account will be described with reference to FIGS. 4 to 11 below.

FIG. 4 is an example diagram illustrating a screen for accessing a manager system, according to an embodiment of the present disclosure. Referring to FIG. 4, a screen for accessing the manager system includes a group ID, an ID, and a password. The group ID is the ID of a learning group managed by an academy. For example, a group ID for ‘math B class’ of ‘comprehensive academy A’ may be ‘math_group_B’. alternatively, a group ID for ‘English C class’ may be ‘English_group_C’. The ID of the administer account may be input as an ID. The password may be a password set in response to the administer account. The administer account may be accessed by inputting a group ID, an ID, and a password.

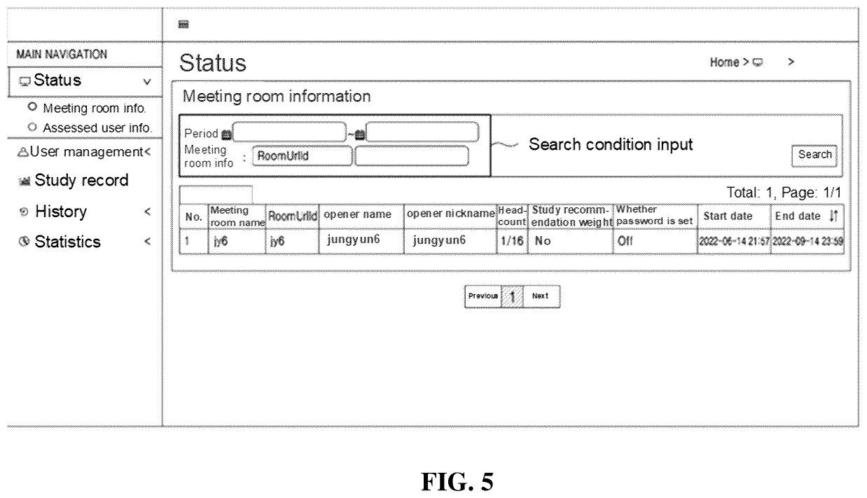

Here, FIG. 5 to FIG. 11 are example diagrams illustrating pages that may be checked with a administer account according to an embodiment of the present disclosure.

Referring to FIG. 5, meeting room information may be searched in the administer account according to an embodiment of the present disclosure. The meeting room corresponding to a condition may be searched by setting the start and end date and time as a period and inputting the meeting room information as a search condition. The meeting room information may be selected from a room URL ID, a room title, and a meeting room opener name and include information corresponding to the related items. The room URL ID is a study URL, the room title is a study (meeting room) name, and the meeting room opener name corresponds to a name of the first person to open the study.

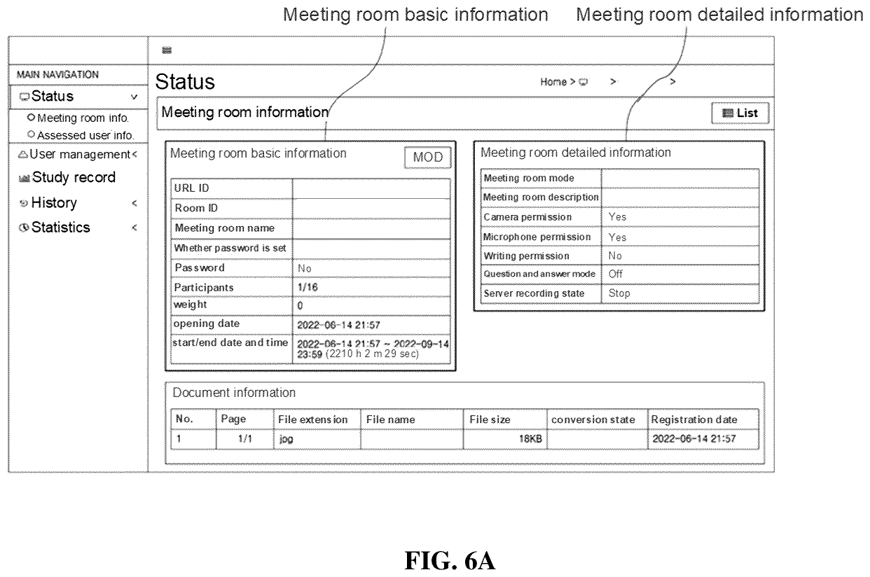

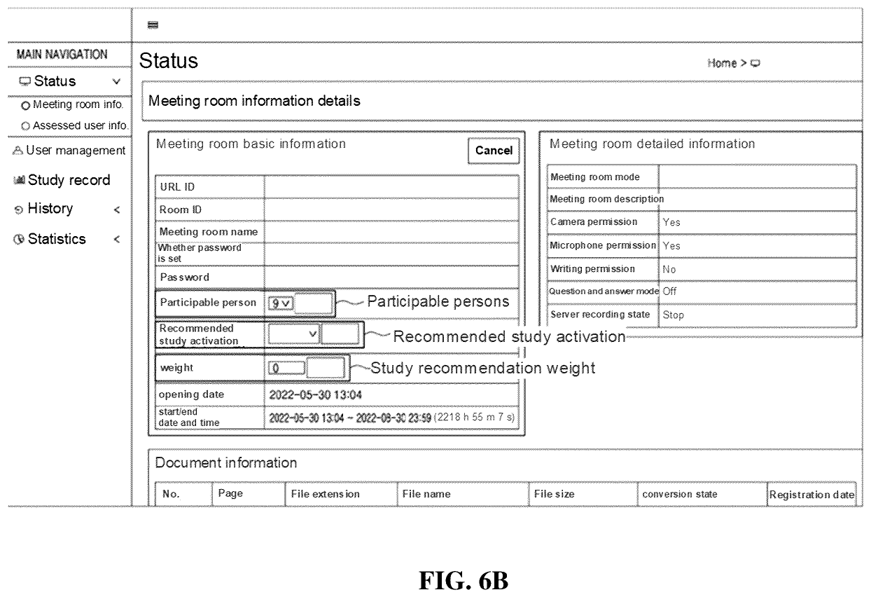

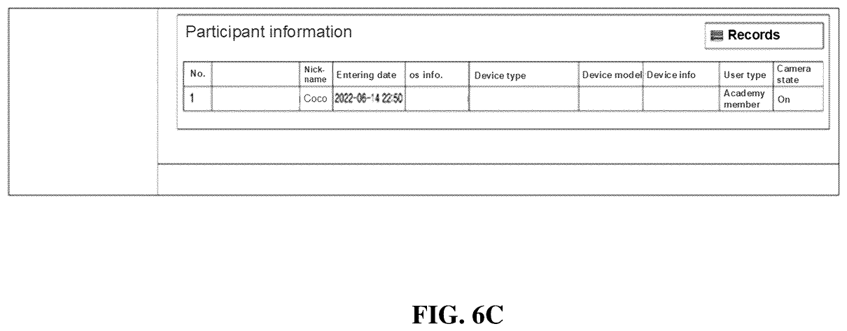

Referring to FIG. 6A, detailed information on the meeting room searched in FIG. 5 may be checked. A meeting room details page provides basic meeting room information including URL ID, room ID, meeting room name, password setting, password, number of participants/number of participable persons, study recommendation weight, meeting room generation date and time, and meeting room start/end date, and meeting room detailed information including meeting room mode, meeting room description, camera permission upon entry, microphone permission upon entry, writing permission upon entry, question and answer mode, and server recording state.

Referring to FIG. 6B, items that may be modified with a administer account may be checked from the meeting room details page of FIG. 6A. The administer account may set the number of participable persons, recommended study activation, and study recommendation weight on the meeting room details page. The maximum number of participable persons may be set for the study room. When the recommended study activation item is activated to access the student terminal 200, ‘recommended study’ may be exposed at the top of the opened study list. The study recommendation weight is a weight illustrated in the ‘recommended study’ list, and the higher the weight, the more the study recommendation weight is displayed at the front.

Referring to FIG. 6C, participant information may be checked on the meeting room details page. A user participating in the study (meeting room) may be searched with the participant information. Also, when the participation record view displayed in one region of a corresponding page is input, a user may move to a page where the user may check the record of the study participation.

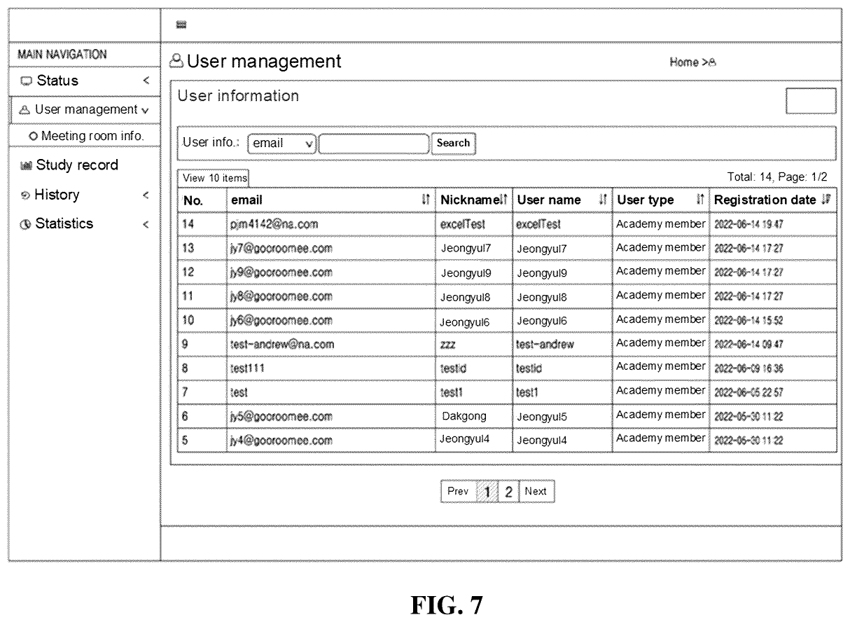

Referring to FIG. 7, user information of a user management may be checked from the administer account according to an embodiment of the present disclosure. A registration button, which takes a user to a screen for registering a new user, is displayed in one region of the screen.

Also, a menu, which allows a user to search for user information by inputting an email and user name, is displayed in one region of the screen. In addition, a region, which displays a list of results obtained by searching for user information, is displayed on the screen. The search results may be sorted in order by number, email, nickname, user name, user type, and registration date. Also, by clicking a user in the search results, the screen may be moved to a detailed information search screen.

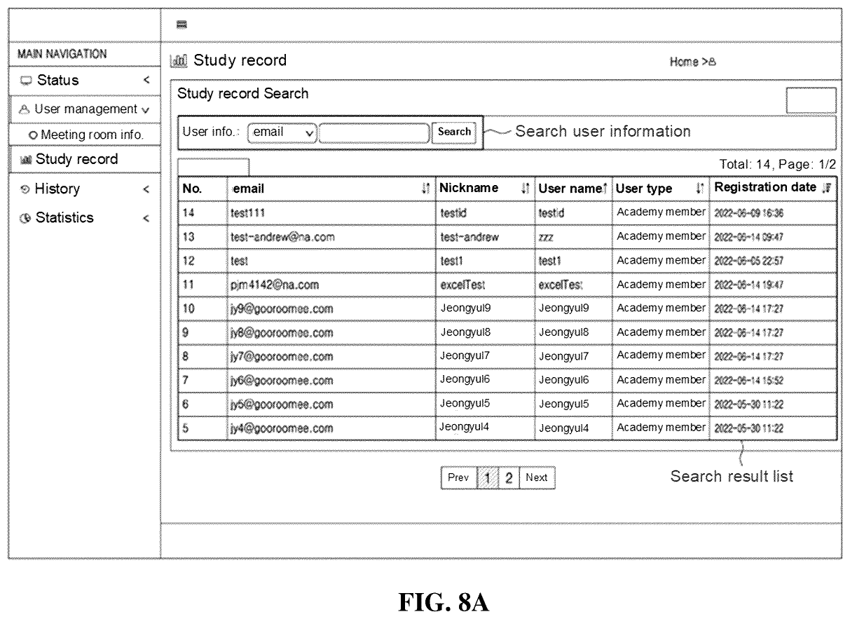

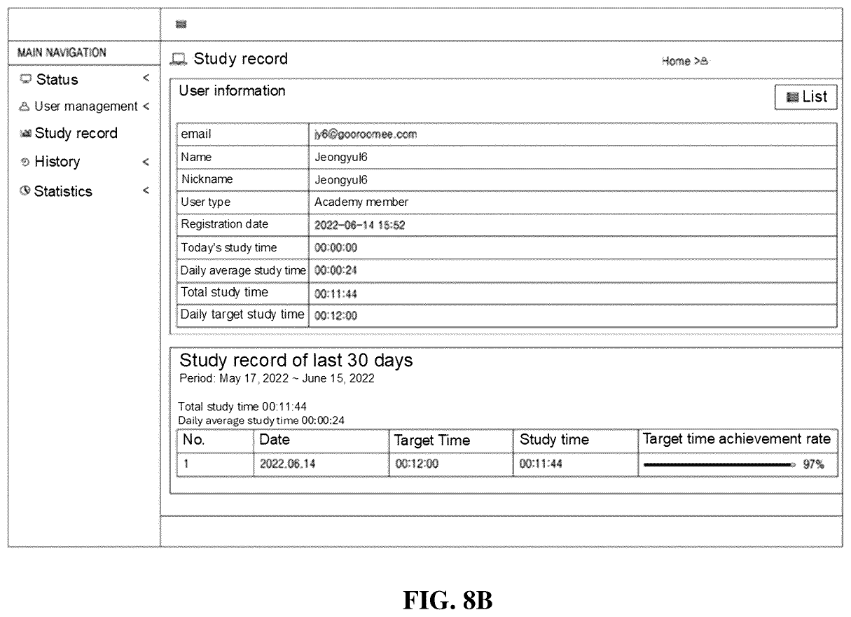

Referring to FIG. 8A and FIG. 8B below, a user may check study records of the student terminal 200 in the administer account according to an embodiment of the present disclosure.

In the page illustrated in FIG. 8A, a menu, which allows a user to search for study records by inputting an email and user name, is displayed in one region of the screen. In addition, a region, which displays a list of results obtained by searching for the study records, is displayed on the screen. The search results may be sorted in order by number, email, nickname, user name, user type, and registration date. Also, by clicking a user in the search results, the screen may be moved to a study record search screen.

FIG. 8B illustrates the study record search screen that is moved by clicking a specific user in the search result list obtained in FIG. 8A. On this screen, a user may check user information, user study records showing study time by period, and study records for the past 30 days. The user may check the study records for the recent 30 days by date in the study records for the recent 30 days. The user may also check an achievement rate compared to the target time. In addition, when the target time is changed, the achievement rate also changes in real time.

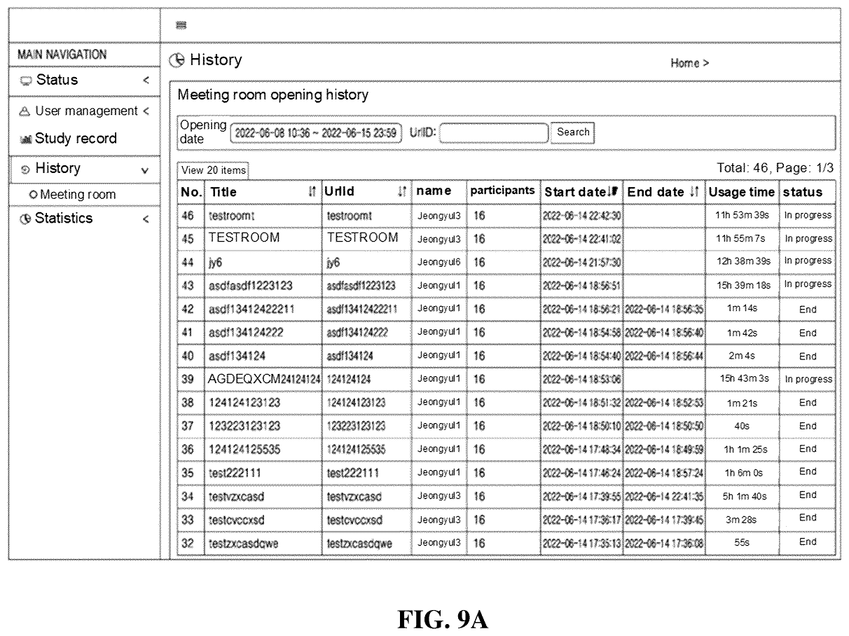

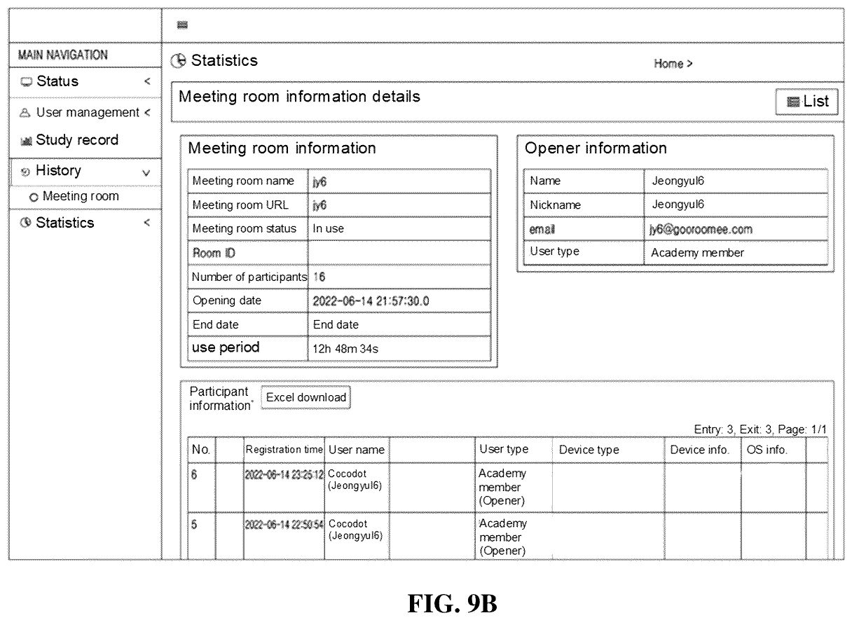

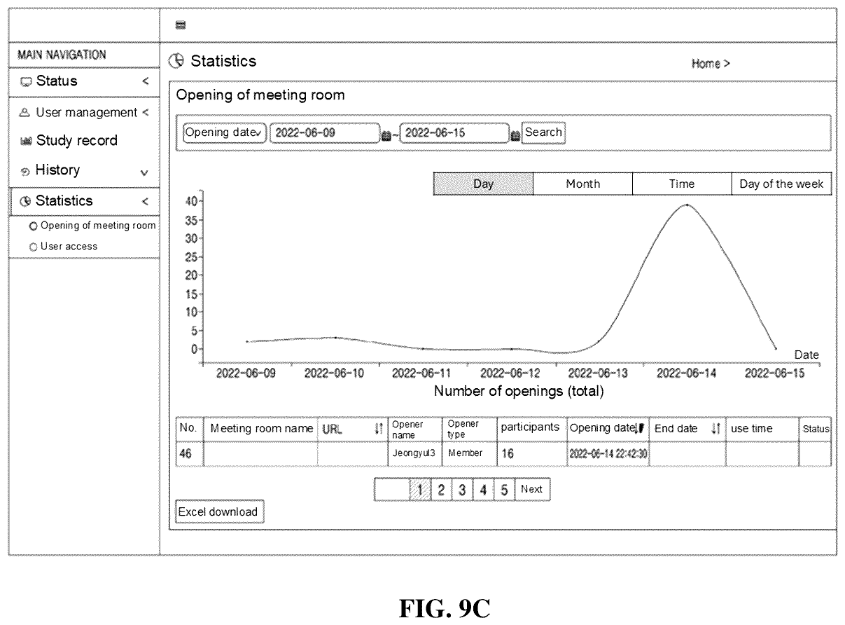

FIG. 9A to FIG. 9C are example diagrams illustrating opening of meeting room and statistics that may be checked from a administer account, according to an embodiment of the present disclosure.

Referring to FIG. 9a, a user may check the entire meeting room opening history according to an embodiment of the present disclosure. On the related page, a user may set the opening date and time and input a URL ID to perform search. In addition, a list of search results that meet the related condition is displayed in one region of the screen. When a user clicks a study in the list of search results, the screen is moved to a screen for searching for detailed information, and description thereof is made below with reference to FIG. 9B.

Referring to FIG. 9B, a user may check the detailed information of the meeting room for the meeting room name ‘jy6’ from the list of search results of FIG. 9A. On this page, a user may check the basic information and history of the study (meeting room), opening information, participant information, and table summary information including the number of entries and exits.

Referring to FIG. 9C, a user may check the study (meeting room) opening statistics during a certain period, according to an embodiment of the present disclosure. A related page provides a period setting menu corresponding to an opening date and time criteria and an end date and time criteria. Also, the search results are displayed on one region of the screen as a graph showing the total number of study (meeting rooms) opened during a period including day, month, time, and day of the week. In addition, the list of search results that meet the search condition is displayed on one region of a screen, and when a user click a study (meeting room) in the list, the screen may be moved to a screen where the user may check detailed history information.

In the study (meeting room) opening statistics page according to an additional embodiment of the present disclosure, a search screen for user access statistics for a specific period may be provided.

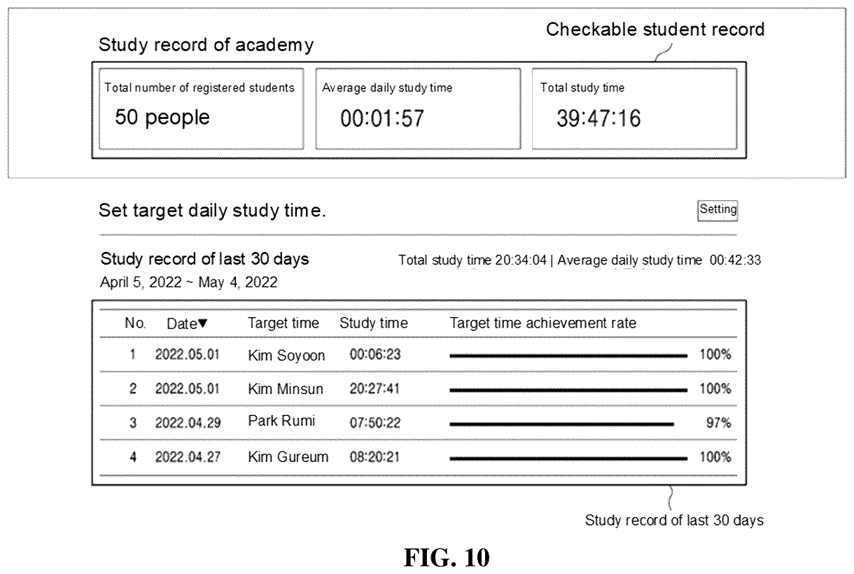

Referring to FIG. 10, a user may check student records including the total number of registered persons, average daily study time, and total study time with the administer account according to an embodiment of the present disclosure. In addition, a user may check the study records for the recent 30 days, and may check the date, study time, and target time achievement rate in detail.

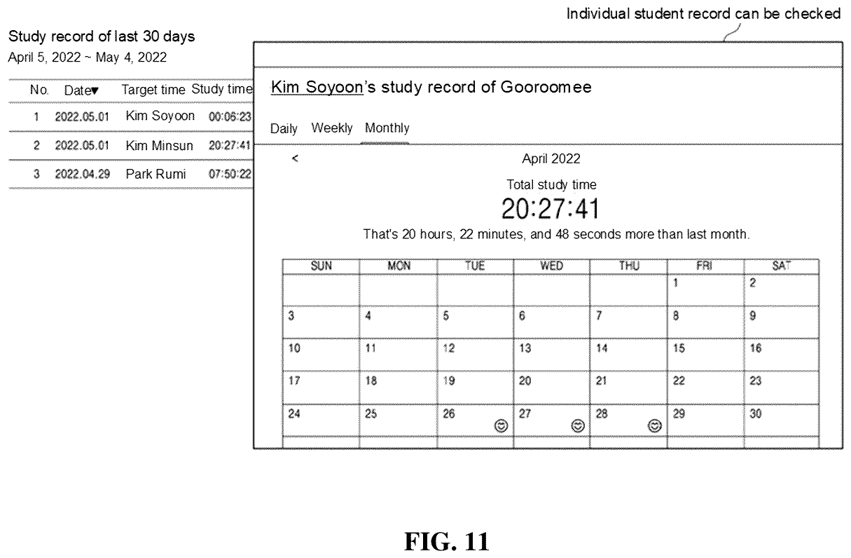

Referring to FIG. 11, a user may check the study records of individual students according to an embodiment of the present disclosure. A user may perform search for each of daily, weekly, and monthly periods in detail, and may check how much the total study time of today, this week, and this month has increased or decreased compared to the previous day, last week, and last month.

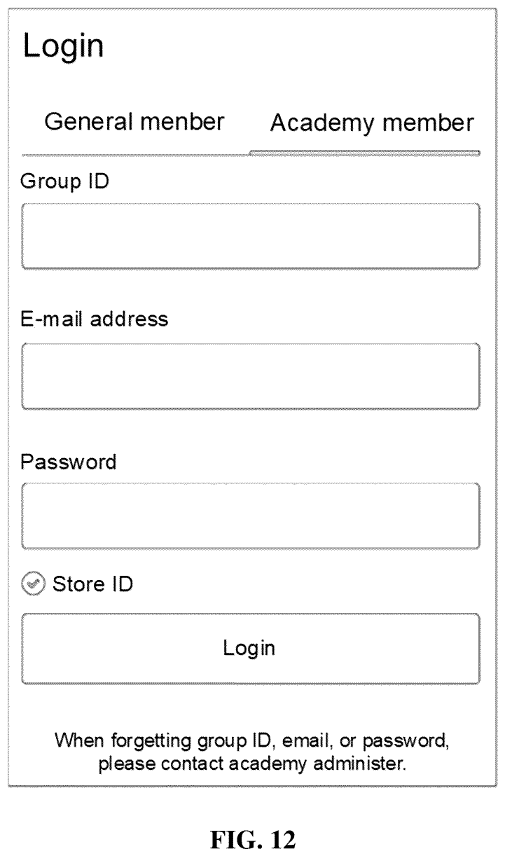

Items that may be checked with the student account are described below with reference to FIG. 12 to FIG. 14.

FIG. 12 is an example diagram illustrating a login screen for the student terminal 200 to access the server 100, according to an embodiment of the present disclosure.

Referring to FIG. 12, a screen for the student terminal 200 to access the server 100 includes a group ID, an ID, and a password. description of the group ID will be replaced with the description given above with reference to FIG. 4. The ID may be an ID of the student account. The password may be a password previously set to correspond to the student account. The student account may be accessed by inputting the group ID, ID, and password.

The same learning goal may be set between student terminals having the same group ID managed by an academy according to an additional embodiment of the present disclosure.

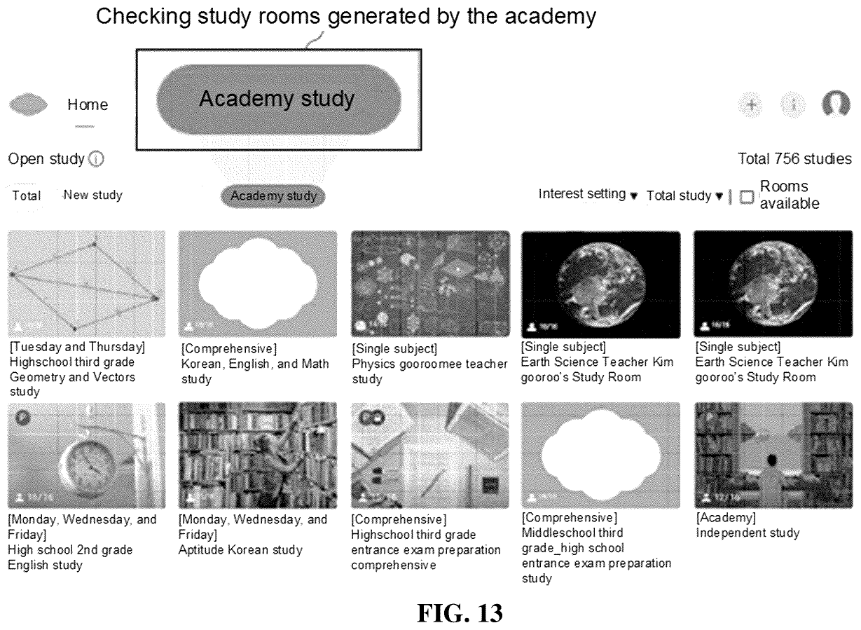

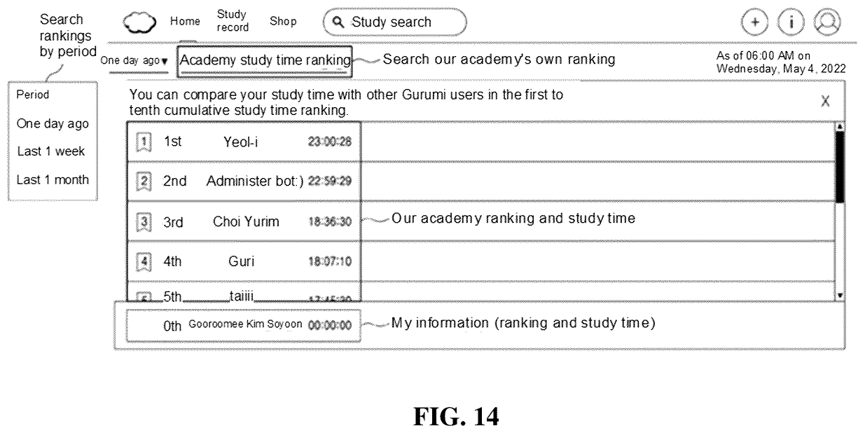

FIG. 13 and FIG. 14 illustrate examples of pages for information that may be searched by accessing the student terminal 200, according to an embodiment of the present disclosure.

Referring to FIG. 13, an academy's open study room may be viewed. The student terminal 200 may check, from the study room page generated by the academy, day of the week, a room title for grade and subject, and the total number of people allowed to enter the room and number of people currently in the room.

Referring to FIG. 14, a user may check the study time ranking of our academy. On this page, a user may check the study time ranking of only our academy, and may check the ranking by setting the period as desired among one day ago, the recent week, and the recent month. Also, a user may check the ranking of top 30 students with the highest cumulative study time at our academy, and a user's cumulative study time is also displayed in one region of a screen.

In addition to the administer account, the server 100 according to an embodiment of the present disclosure may provide an observer account to the academy terminal 300, and the observer account may access the open webcam study room generated by the academy terminal 300, and even when a user accesses the open webcam study room, the existence of the academy terminal 300 is not exposed to the student terminal 200. Also, the administer account and the observer account may be issued as one account.

Next, the academy terminal 300 requests the server 100 to open an open webcam study room (S420). The academy terminal 300 may request the server 100 to open the open webcam study room such that the student terminal 200 may access the server 100 to perform study.

In addition, the server 100 generates (opens) the open webcam study room (S430). The server 100 may open the open webcam study room according to the request of the academy terminal 300.

Next, the student terminal 200 requests the server 100 to check and enter the open webcam study room generated by the academy terminal 300 (S440). When the student terminal 200 accesses the server 100, the server 100 recognizes the identification information of the academy terminal 300 that is previously stored by being matched to the student terminal 200, and transmits the identification information of the open webcam study room generated by the academy terminal 300 to the student terminal 200 such that the open webcam study room is exposed to the student terminal 200.

In this case, the student terminal 200 may check any open webcam study room generated by another student terminal 200 in addition to the open webcam study room generated by the exposed academy terminal 300, and may request the server 100 to allow the student terminal 200 to enter the open webcam study room that the student terminal 200 wants.

In addition, the server 100 accepts the entry request of the student terminal 200 (S450). Then, the server 100 provides a video of another student terminal 200 that enters the open webcam study room and transmits the video of the accessed student terminal 200 to another student terminal 200 (S460).

When the server 100 may accept the entry request of the student terminal 200, the student terminal 200 enters the open webcam study room requested to enter, and may receive, from the server 100, videos of other student terminals 200 that are entered previously. In addition, the student terminal 200 may receive video of other student terminals 200, and at the same time, may transmit the videos to the other student terminals 200 through the server 100. In this case, videos may be captured by a camera mounted on or connected to the student terminal 200.

Since the open webcam study room is used for learning, sound is not transmitted, and when the student terminal 200 wants, the sound may be turned on, and through this, the student terminal 200 may communicate with other student terminals 200 by asking or receiving questions about learning.

The server 100 may check change values of image pixels received through a camera of the student terminal 200 in real time, and when the change values of the image pixels are zero for a preset time or longer, it is determined that the student terminal 200 does not sit in the seat without studying, and may provide an alarm message to other student terminals 200 or stop an operation of a study record timer.

Also, when the student terminal 200 enters the open webcam study room, the server 100 may monitor the change values of the image pixels in real time, and when the change values of the image pixels are zero for a preset time or longer, it may be determined that the student terminal 200 does not sit in the seat without studying.

In this case, when it is determined that a student does not sit in the seat for a preset time or longer, the current time and the previously stored a class timetable of the student are compared with each other, and
whether the current time is within one of the class time ranges of the student's class timetable, and when the current time is included in any class time range, it may be recognized that the student terminal is participating in the class.

For example, when no change in the image pixels is detected for 20 minutes after 1:30 PM from a student terminal accessed the open webcam study at 1:00 PM, it may be determined that the student is away from the seat, and at this time, when the class time is set from 1:40 PM to 2:30 PM on the class timetable of the student terminal, it may be recognized that the student is not away from the seat but is participating in the class.

According to an embodiment of the present disclosure, when a student terminal enters the open webcam study room and performs a study and has a question about the study, the student may open a chatting window previously set in one region of a screen of the open webcam study room and input the question thereto.

Then, the server may receive a question from the student terminal 200, classify items of the question through a pre-learned question classification model, determine to which model among multiple artificial intelligence learning models the question is input by referring to a classification value, and input the question to the determined model to output an answer therefor. For example, an artificial intelligence (AI) model for math problems and an AI model for Korean problems are built separately. However, sending and receiving questions are not limited to the student terminal 200. The question may be transmitted to and received by a smart terminal installed separately in a reading room space at an academy.

In addition, the server 100 may transmit the printed answer to the student terminal 200.

At this time, the item is one subject that the student terminal learns, and each AI learning model may be trained with learning data consisting of different question data and answer data in pairs depending on items.

When the student terminal 200 according to an additional embodiment of the present disclosure does not have a camera, a transmission screen of the student terminal 200 may be replaced with a preset image.

In addition, the server 100 records the time that the student terminal 200 accesses the open webcam study room and performs an activity as study time and transmits the recorded data to the academy terminal 300 (S470). The student terminal 200 may access the open webcam study room to do study and does study by turning on the sound and communicating with other student terminals 200. The studies made in various ways are recorded as study time by a study record timer that measures the start and end times of study. Here, the study record timer may also set a break time alarm. In addition, the academy terminal 300 may check the study record of the student terminal 200 for each period and check the history of the open webcam study room opening. As described above, the data on the time that the student terminal 200 accesses the open webcam study room and the data on the study time and break time measured by the study record timer are stored in the server 100. The server 100 may provide the data on the study time of the related student terminal 200 to the academy terminal 300 such that the data may be checked from the administer account when there is a request from the academy terminal 300.

According to an embodiment of the present disclosure, a preset AI model may analyze the study record and show the ranking of the items preset by the student terminal. For example, the ranking for an increase rate (rate of rise) of the study time compared to the previous week, or the ranking of the students who frequently ask questions related to the study may be included.

In an additional embodiment of the present disclosure, the preset AI model may collect study data, such as study record, study time zone, study time for each subject, average score of the subject solved during the self-study time, and study concentration of each student terminal, and may derive the self-study efficiency of the related student terminal by referring to the score for each subject in a monthly mock test.

Specifically, the study records of each student terminal may be checked by tracking the time and time period from opening of the open webcam study to closing of the open webcam study by accessing the server 100. In the case of study time for each subject, the student terminal 200 may estimate the subject by directly inputting the subject information or extracting a text in an image from a test paper image received through a camera, and the study time based on the related test paper may be checked by taking a picture with a computer camera.

The average score of the subject solved during the self-study time may be checked based on the student terminal's score when solving the problems of each subject provided through the server 100 after accessing the open webcam study. The study concentration may be checked based on a case where a camera detects that a student is dozing off or sleeping face down.

Learning may be performed by using a model based on at least one of RNN, LSTM, and CNN by setting the identified study data and monthly mock test scores for each subject of the related student terminal 200 as input values and setting an output value as the self-study efficiency of the student terminal 200. Through this, when a student enters an open camp study room and studies on his/her own, it is possible to check which subject is most efficient for self-study and at what time of day the student may study most efficiently, and by providing this information to the student, the student may be guided to study with the best efficiency during the student's self-study time.

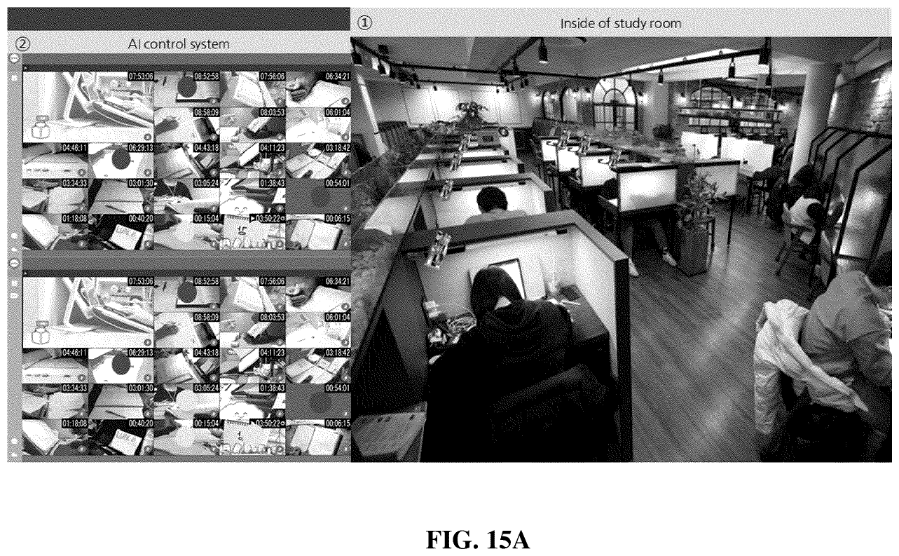

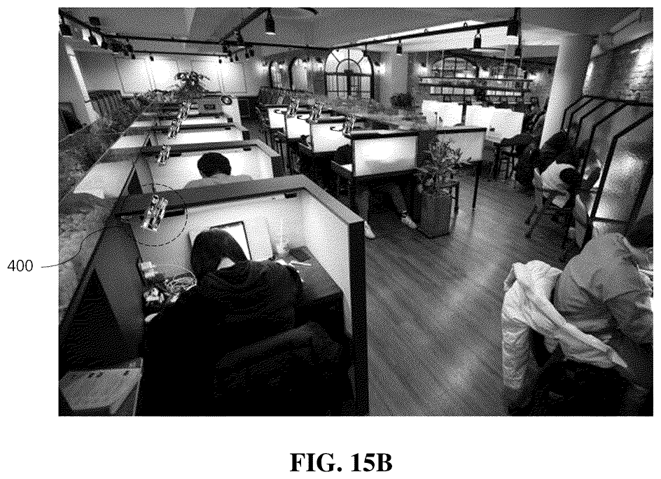

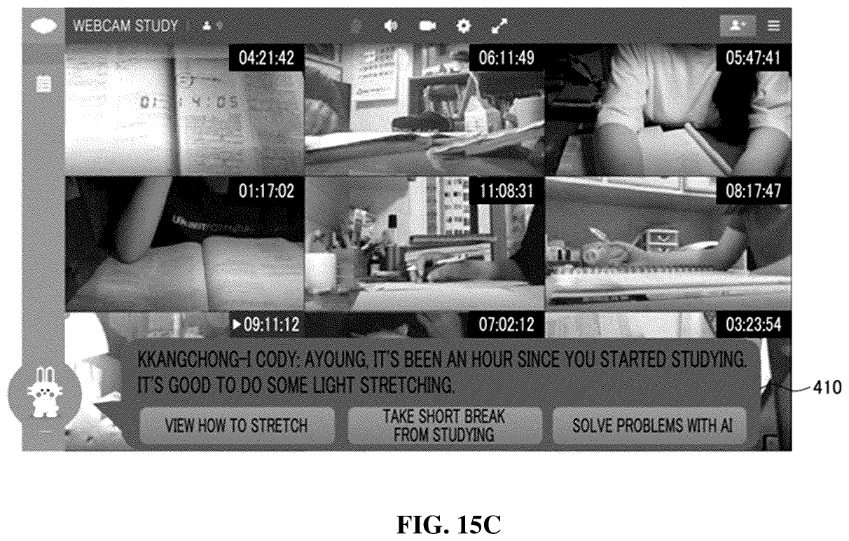

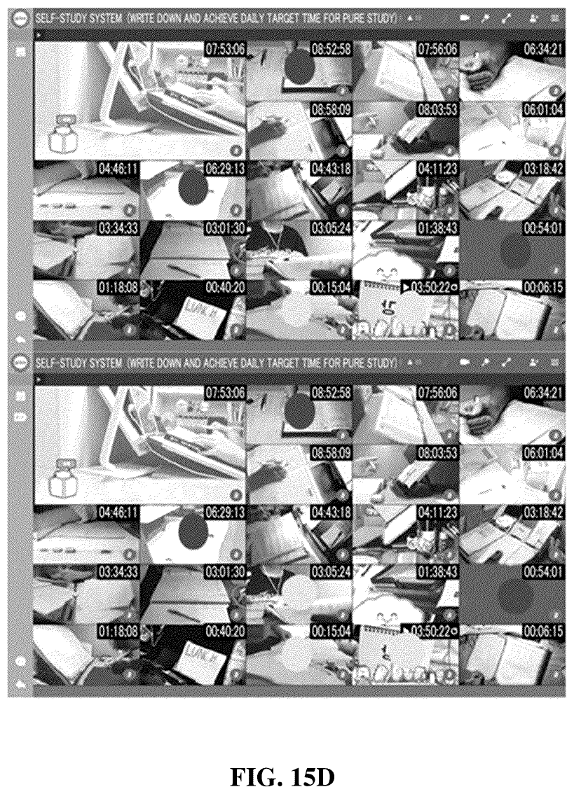

FIG. 15A to FIG. 15D are example views illustrating a student monitoring screen according to an embodiment of the present disclosure.

Referring to FIG. 15A to FIG. 15d, the academy terminal 300 may monitor students and student terminals (or smart terminals) participating in the open webcam study room. The entire monitoring screen may be composed of a study room internal screen \textcircled{1} and an AI control system screen \textcircled{2} as illustrated in FIG. 15A. The study room internal screen \textcircled{1} is a screen on which students studying in the study room may be monitored in real time, and a configuration of the study room internal screen is illustrated in FIG. 15B.

Referring to FIG. 15B, a study monitoring screen 400 is provided for each seat, and in this case, the study monitoring screen 400 may be checked by using a student terminal or a smart terminal installed by the academy, and a configuration of the study monitoring screen 400 is illustrated in FIG. 15C.

Referring to FIG. 15C, the study monitoring screen 400 is configured with a grid such that states of other students accessing the open webcam study room and performing study may be checked. In addition, when a preset time elapses, a notification provided by the server 100 may be displayed on the study monitoring screen 400.

For example, when 1 hour of study time elapses, a menu including “viewing a stretching method”, “taking a break time”, and “solving problems with AI” may be displayed on the study monitoring screen 400 together with a phrase, “Mr./Mrs. OO, one hour elapsed since you started studying. It will be good to do some light stretching”. In this case, the student may select a desired menu and continues taking a break or studying.

Referring to FIG. 15D, the AI control system screen may provide the entire student terminal or smart terminal in the form of a grid. In addition, as described above, the screen may be monitored in real time, and whether the student terminal does not sit in the seat or moved to participate in class may be analyzed.

In an additional embodiment of the present disclosure, a student terminal may replace a transmission screen with a preset image to prevent personal information from leaking out. However, even when the transmission screen is replaced with an image, the movement of a student may be monitored by a camera, whether the student does not sit in the seat or moved to participate in class may be analyzed. That is, although the screen is not transmitted to another student terminal, monitoring may be continuously performed whether students do not sit in seats, there is no movement, or moved to participate in class.

According to the present disclosure, a student terminal may access a server and access an open webcam study room generated by an academy terminal or another student terminal to perform study, store a record thereof in the server, and accordingly the academy terminal organically manage study states of the student terminals.

An embodiment of the present disclosure may be performed in the form of a recording medium including instructions executable by a computer, such as a program module executed by a computer. A computer readable medium may be any available medium that may be accessed by a computer and includes both volatile and nonvolatile media, removable and non-removable media. Also, the computer readable medium may include a computer storage medium. A computer storage medium includes both volatile and nonvolatile media and removable and non-removable media implemented by any method or technology for storing information, such as computer readable instructions, data structures, program modules or other data.

Although the method and system of the present disclosure are described with respect to specific embodiments, some or all of components or operations thereof may be implemented by using a computer system having a general-purpose hardware architecture.

The above description of the present disclosure is intended to be illustrative, and those skilled in the art will appreciate that the present disclosure may be readily modified in other specific forms without changing the technical idea or essential characteristics of the present disclosure. Therefore, the embodiments described above should be understood as illustrative in all respects and not limiting. For example, each component described in a single type may be implemented in a distributed manner, and likewise, components described in a distributed manner may be implemented in a combined form.

The scope of the present application is indicated by the claims described below rather than the detailed description above, and all changes or modified forms derived from the meaning, scope of the claims, and their equivalent concepts should be interpreted as being included in the scope of the present application.

What is claimed is:

1. A method for providing a webcam study management service for private educational institute by a server, the method comprising:
providing a administer page to an academy terminal;
receiving a request for opening an open webcam study room from the academy terminal and generating the open webcam study room by being matched to identification information of the academy terminal;
exposing the open webcam study room generated by the academy terminal when a student terminal accesses the server, accepting an entry request when the student terminal requests to enter to the open webcam study room, providing videos of other students who have already entered in the open webcam study room, shooting a video of the student using the accessed student terminal, and transmitting the shooted video to terminals of the other students; and
recording the study time of the student based on a time period when the student terminal accesses the open webcam study room and engages in study activities, and transmitting the recorded study time to the academy terminal.

2. The method of claim 1, wherein, in the providing of the administer page,
an account for accessing the administer page is issued,
the account includes a administer account and an observer account,
the administer account has authority to view a study record related to study hours of students registered in the academy,
the observer account is accessible to the open webcam study room generated by the academy terminal and allows viewing videos of all student terminals in the open webcam study room, and existence of the academy terminal is not exposed to all student terminals, and
the administer account and the observer account are integrated into a single account.

3. The method of claim 2, wherein, in the recording of the study time,
by accessing the administer account, cumulative study times of the student terminal, the open webcam study room status of the academy, and study record information for each student terminal can be viewed on the administer page,
the server stores a data about access time of the student terminal to the open webcam study room, a study time and a break time measured by a study record timer,
the data is provided to the academy terminal to be viewed with the administer account when there is a request from the academy terminal, and
a study record for each period of the student terminal and an opening history of the open webcam study room are provided to the academy terminal.

4. The method of claim 3, wherein, in the exposing of the open webcam study room, the accepting of the entry request, the providing of the videos, the shooting of the video, and the transmitting of the video,
when the student terminal accesses the server, the identification information of the academy terminal that is previously stored is recognized by being matched to the student terminal,
identification information of the open webcam study room generated by the academy terminal is transmitted to the student terminal such that the open webcam study room is exposed to the student terminal,
the student terminal accesses the open webcam study room generated by an academy to which the student is registered or accesses any other open webcam study room, and performs study by using the study record timer,
the study record timer measures a study start time and a study end time of the student and sets break time alarm, and
change values of image pixels received from the student terminal are checked in real time, and when the change values of the image pixels are zero for a preset time or longer, the student is determined to be away from their seat and not studying, and an alarm message is provided to the student terminal.

5. The method of claim 4, wherein, in the exposing of the open webcam study room, the accepting of the entry request, the providing of the videos, the shooting of the video, and the transmitting of the video,
when the student terminal enters the open webcam study room, the change values of the video pixels are monitored in real time,
when the change values of the video pixels remain at zero for a preset time or longer, the student is determined to be away from their seat and not studying,
when the student is determined to be away from their seat for the preset time or longer, a current time and a previously stored class timetable of the student terminal are compared to each other, and whether the current time is included in any class time range of the class timetable of the student terminal is checked, and
when the current time is included in the class time range, the student terminal is determined to be participating in a class.

6. The method of claim 1, wherein the exposing of the open webcam study room, the accepting of the entry request, the providing of the videos, the shooting of the video, and the transmitting of the video includes:
when the student terminal enters the open webcam study room and has a question about study while performing the study,
opening a chatting window set in one region of a screen of the open webcam study room and inputting a question;
classifying, by the server, items of the question through a pre-trained question classification model;
determining, based on the classification value, which model among multiple artificial intelligence learning models should receive the question, and inputting the question to the determined model and outputting an answer; and
transmitting an output answer to the student terminal,
the items are included in one subject studied by the student terminal, and
the multiple artificial intelligence learning models are trained with learning data comprising different question data and answer data in pairs according to the items.

7. The method of claim 3, wherein
a pre-set artificial intelligence model analyzes the study record, and
the student terminal shows rankings of preset items.

8. The method of claim 7, wherein
the pre-set artificial intelligence model:
collects study data for each student terminal, including a study record, a study time period, a study time for each subject, an average score of subjects solved during self-study time, and study concentration,
derives self-study efficiency of the student terminal by referring to subject scores of test results executed for each pre-set period,
tracks and identifies the study record by monitoring the time when the student terminal accesses the server, opens the open webcam study room, and closes it,
estimates the study time for each subject based on subject information directly input by the student terminal or by extracting text from a test paper image captured by the student terminal's camera,
identifies the average score of subjects solved during self-study time based on scores obtained when the student terminal accesses the open webcam study room and solves subject-specific problems provided through the server,
determines the study concentration by detecting instances of the student dozing off or sleeping face down, as captured by the camera, and
performs training using a model based on at least one of RNN, LSTM, and CNN, by setting the study data and monthly mock test scores for each subject of the corresponding student terminal as input values and by setting the self-study efficiency of the student terminal as an output value.

9. The method of claim 1, wherein,
when the student terminal is matched to multiple academy terminals and each of the multiple academy terminals has the administer account,
even when the student terminal accesses the open webcam study room generated by one of the multiple academy terminals and performs study, a record of the study time performed by the student terminal is also provided to accounts of other academy terminals.

10. A device for providing a webcam study management service for private educational institute, the device comprising:
a memory storing a program for the webcam study management service for the academy; and
a processor configured to execute the program,
wherein the processor performs:
an operation of providing a administer page to an academy terminal;
an operation of receiving a request for opening an open webcam study room from the academy terminal and generating the open webcam study room by being matched to identification information of the academy terminal;
an operation of exposing the open webcam study room generated by the academy terminal when a student terminal accesses the server, accepting an entry request when the student terminal requests to enter to the open webcam study room, providing videos of other students who have already entered in the open webcam study room, shooting a video of the student using the accessed student terminal, and transmitting the shooted video to terminals of the other students; and
an operation of recording the study time of the student based on a time period when the student terminal accesses the open webcam study room and engages in study activities, and transmitting the recorded study time to the academy terminal.
